(19) United States
(12) Patent Application Publication
(10) Pub. No.: US 2007/0202820 A1
(43) Pub. Date: Aug. 30, 2007

(54) Method for determining a value of the transmission power for a signal that is to be transmitted from a transmitter station to a receiver station and associated device

(76) Inventors: Egon Schulz, Munchen (DE); Wolfgang Zirwas, Munchen/Lochhausen (DE)

Correspondence Address: STAAS & HALSEY LLP, SUITE 700, 1201 NEW YORK AVENUE, N.W., WASHINGTON, DC, 20005, US

(21) Appl. No.: 11/630,885

(22) PCT Filed: Apr. 20, 2005
(86) PCT No.: PCT/EP05/51752

§ 371 Date: Dec. 27, 2006

(30) Foreign Application Priority Data
Jun. 28, 2004 (EP) 04015137.5

(51) Int. Cl. H04B 1/04

(52) U.S. Cl. 455/127.1; 455/522

(57) ABSTRACT

A method determines a value of the transmission power for a signal that is to be transmitted from a transmitter station to a receiver station. According to said method, for a first value of the transmission power, the transmitter station estimates the position of a prospective first value of the receiving power of the receiver station in a predefined receiving power interval. A second value of the transmission power that is to be sent is determined by the transmitter station in such a way that when said value is used a prospective second value of the receiving power lies closer to the centre of the predefined receiving power interval than the prospective first value of the receiving power.

### CROSS REFERENCE TO RELATED APPLICATIONS

This application is based on and hereby claims priority to Application No. PCT/EP2005/051752 filed on Apr. 20, 2005 and European Application No. 04 015 137, filed Jun. 28, 2004, the contents of which are hereby incorporated by reference.

### BACKGROUND

The invention relates to a method for determining a value of the transmitting power for a signal requiring to be transmitted from a transmitting station to a receiving station and to an associated device.

One of the most important techniques employed in managing the radio resources of radio-communication systems is the matching of transmission methods to the transmission conditions prevailing in the radio channels used. The technical term employed for this is “link adaptation”. Link adaptation in particular enables the data throughput rate to be maximized as a function of a radio channel's prevailing transmission conditions. Link adaptation has been standardized for, for example, HiperLAN (High Performance Radio Local Area Network) and HSDPA (High Speed Downlink Packet Access) and is effected by, for instance, matching the modulation format or coding rate used for the radio transmission.

In OFDM (Orthogonal Frequency Division Multiplex) systems, symbols are transmitted from a transmitting to a receiving station. Each symbol includes a plurality of signals transmitted via in each case one subcarrier. The subcarriers are mutually orthogonal and employ different carrier frequencies, so that different transmission conditions for the individual subcarriers can occur in the case of a frequency-dependent transmission channel. Owing to the transmission channel's said frequency dependency, link adaptation must be performed separately for each subcarrier. That requires knowledge in the transmitting station about the transmission channel's state (CSI: Channel State information) for each individual subcarrier. In TDD (Time Division Duplex) systems, the transmitting station, for instance a base station, receives channel state information through, for example, a channel estimation of the transmission channel on the uplink (UL), which is to say from the receiving to the transmitting station. In FDD (Frequency Division Duplex) systems, frequencies different from those used on the uplink are used for transmissions on the downlink (DL), which is to say from the transmitting to the receiving station. The transmitting station thus requires feedback from the receiving station about the transmission channel's characteristics determined by the receiving station. Using channel state information for the individual subcarriers that is available in the transmitting station, a modulation method for the signals requiring to be transmitted can, for example, be selected for each subcarrier individually as a function of the prevailing channel conditions.

So that on receiving the subcarriers' signals the receiving station will for each of the signals employ the modulation method corresponding to the subcarrier, information about the modulation method must be conveyed from the transmitting station to the receiving station directly or indirectly. Direct notification means in this case that the transmitting station will signal the modulation type used for each subcarrier to the receiving station explicitly. That is particularly disadvantageous when the number of subcarriers is large and transmission conditions change quickly over time. There would in that case be an extremely high signaling load. Another possibility is offered by what are termed blind detection schemes whereby the modulation method used is estimated for the individual subcarriers by the receiving station. That is done by, for example, specifying receiving-power intervals to which in each case a specific modulation method is assigned and which are known to both the transmitting and the receiving station from the outset. Based on the respective transmission conditions known to it, the transmitting station estimates the receiving station's respective receiving power for each subcarrier and, for the ensuing transmission, selects in each case the modulation method assigned to the receiving-power interval in which the respective estimated receiving-power value lies. The receiving station measures the receiving power of the signals received on the subcarriers and, for demodulating the signals, employs in each case the demodulation method corresponding to the modulation method of the corresponding receiving-power interval in which the respectively measured receiving power lies.

Errors can occur during selecting of the demodulation method by the receiving station owing to the receiving power estimated by the transmitting station lying in a receiving-power interval different from that in which the receiving power actually measured by the receiving station lies. That will occur when, for example, transmission conditions prevail during transmission from the transmitting station to the receiving station that are different from those assumed by the transmitting station based on the transmission conditions known to it.

### SUMMARY

One potential object of the invention is thus to disclose an advantageous method for determining a value of the transmitting power for a signal requiring to be transmitted from a transmitting station to a receiving station, as well as an associated device, by both of which the receiving station will be enabled to determine the modulation method used by the transmitting station with a reduced probability of error compared with known methods.

The inventors propose a method for determining a value of the transmitting power for a signal requiring to be transmitted from a transmitting station to a receiving station, for a first value of the transmitting power the position of a prospective first value of the receiving station's receiving power in a predefined receiving-power interval is estimated on the transmitter side. A second value, to be used for transmitting, of the transmitting power is determined on the transmitter side in such a way that when said value is used a prospective second value of the receiving power lies closer to the center of the predefined receiving-power interval than does the prospective first value of the receiving power.

What is achieved by the method is a reduced probability that the value of the receiving power actually measured by the receiving station will lie in a receiving-power interval different from that determined, based on the estimation, by the transmitting station. If, for example, the receiving station is to perform different measures depending on the predefined receiving-power interval determined based on the measured value of the receiving power, then the probability that the specific measure assigned to the receiving-power interval determined, based on the estimation, by the transmitting station will be performed will be increased. To be understood as an instance of measures of said type is any form of controlling the receiving station that is to take place and/or will achieve a desired effect only when the receiving-power interval estimated by the transmitting station tallies with the receiving-power interval determined by the receiving station.

What can be understood by estimating the position of the prospective first value of the receiving power in the predefined receiving-power interval is both estimating a specific numerical value for the first value of the receiving power and estimating the relative position of the first value of the receiving power in terms of the interval limits of the predefined receiving-power interval. In the latter case, knowledge of a specific numerical value of the first value of the receiving power is not necessary.

It is especially advantageous for a modulation type used for transmitting the signal to be selected on the transmitter side as a function of which of at least two predefined receiving-power intervals is that in which the prospective first value, estimated on the transmitter side for the first value of the transmitting power, of the receiving power lies. Thanks to the method the receiving station is able, using the measured receiving power, to determine the receiving-power interval estimated by the transmitting station with less probability of error and to select the specific modulation type assigned to said receiving-power interval. A relevant table indicating the assignment of receiving-power intervals to modulation types is stored in both the transmitting and the receiving station for example.

In a development the second value of the transmitting power to be used for transmitting is determined on the transmitter side in such a way that when said value is used the prospective second value of the receiving power lies substantially in the center of the predefined receiving-power interval. The distance of the prospective second value of the receiving power from both the upper and lower limit of the corresponding predefined receiving-power interval will in this way be maximized. The probability that the receiving station will determine a receiving-power interval different from that estimated by the transmitting station owing to, for example, changing transmission conditions or to measuring errors will be minimized by said development.

It is advantageous for the procedural steps to be performed analogously for further signals transmitted simultaneously with the signal from the transmitting station to the receiving station, with a symbol requiring to be transmitted from the transmitting station being assembled from all said signals and the signals being transmitted using different carrier frequencies. The method can in this way be used in, for example, an OFDM system. In an OFDM system an OFDM symbol is formed from a plurality of signals transmitted in each case on a subcarrier, which is to say employing different carrier frequencies. Owing to the transmission channel's frequency dependency, each subcarrier has individual transmission characteristics. For the signals transmitted on the subcarriers an especially favorable modulation method can therefore be selected individually taking the prevailing transmission conditions into account.

Because the second value of the transmitting power of the individual signals can be both higher and lower than the first value of the transmitting power, on average only little additional transmitting power or none at all, or even less transmitting power will be needed when the method is implemented in, for example, an OFDM system. Raising and lowering the respective second value of the transmitting power for signals of the individual subcarriers compared with the first value of the transmitting power will, when there is a large number of subcarriers (for example 64) each having individual transmission characteristics, on average produce a change in the overall transmitting power of the transmitting station that will be close to 0 dB.

It is expedient for pilot signals to be used as the signal and as further signals. Pilot signals are used by the receiving station for estimating the transmission channel at the frequency employed for the respective pilot signal. In addition to channel estimating, pilot signals can thanks to the method be used also for determining and selecting, on the receiver side, modulation methods employed by the transmitting station. For example, the transmitting station first transmits pilot signals on the subcarriers of an OFDM system. The transmitting station then transmits signals of, for example, an OFDM symbol on the subcarriers that carries useful data and employs in each case a modulation method for said signals that corresponds to the receiving-power interval estimated on the transmitter side for the corresponding pilot signal. Using the measured receiving power of the pilot signals, the receiving station determines in each case predefined receiving-power intervals as well as the modulation methods assigned to the receiving-power intervals, then employs said determined modulation methods for the signals, received on the subcarriers, of the OFDM symbol carrying useful data. Owing to the method, it is not necessary to determine the receiving power of the signals of the OFDM symbol carrying useful data. It is of practical advantage for the transmitting station to transmit the pilot signals at a repetition rate that will be the greater the faster the transmission characteristics for signals of the subcarriers change.

Changes in the transmission characteristics and inaccuracies in measuring can cause the receiving station to measure a receiving power different from that estimated by the transmitting station. That problem will arise particularly when receiving powers are low and the signal-to-noise ratio is poor. It is hence expedient for a first predefined receiving-power interval to be larger than a second predefined receiving-power interval and for the receiving powers of the first predefined receiving-power interval to be at the same time lower than the receiving powers of the second predefined receiving-power interval.

In an embodiment a predetermined value is used as the first value of the transmitting power. Said predetermined value can be both the same and different for the signal and for the further signals.

The device exhibits all the features needed to implement the method. It is in particular possible to provide suitable units for implementing the individual procedural steps or variants of the method.

The device can be located both in the transmitting station and in a facility connected thereto. The transmitting station and said facility are connected in the last-cited instance for example on a line-linked basis or via an air interface.

### BRIEF DESCRIPTION OF THE DRAWINGS

These and other objects and advantages will become more apparent and more readily appreciated from the following description of the preferred embodiments, taken in conjunction with the accompanying drawings of which:

FIG. 1 is a schematic of transmitting a symbol formed from a multiplicity of signals from a transmitting to a receiving station,

FIG. 2 is a schematic of predefined receiving-power intervals and of first and second values, estimated by the transmitting station, of the receiving powers for signals of different subcarriers of a symbol transmitted according to FIG. 1.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

Identical references are employed in the figures to identify identical items.

A user station will be considered below as the receiving station, but with no intention to convey that this application is restricted thereto.

A user station is, for example, a mobile telephone, but it can also be a portable or stationary device for transmitting image and/or sound data, for faxing, sending Short Message Service (SMS) messages and/or e-mailing, and/or for accessing the internet.

A base station will be considered below as the transmitting station, but with no intention to convey that this application is restricted thereto.

A base station is a network-side facility forming part of a radio-communication system. The base station sets up a radio link to a user station and exchanging useful and/or signaling data.

The method can advantageously be used in any radio-communication systems. What is to be understood by radio-communication systems are systems in which data is transmitted between stations over a radio interface. Said transmitting of data can be both bidirectional and unidirectional. Radio-communication systems are in particular any mobile-radio systems conforming to, for example, the GSM (Global System for Mobile Communications) or UMTS (Universal Mobile Telecommunications System) standard. Radio-communication systems are to be understood also as including future mobile-radio systems, for example belonging to the fourth generation, as well as ad-hoc networks. Radio-communication systems are, for example, also wireless local area networks (WLANs) conforming to the IEEE (Institute of Electrical and Electronic Engineers) 802.11a-i, HiperLAN1, and HiperLAN2 standards as well as Bluetooth networks.

The method is described below using as an example a mobile-radio system that employs OFDM for transmitting information units, for example bits, but with no intention to convey the method is restricted thereto.

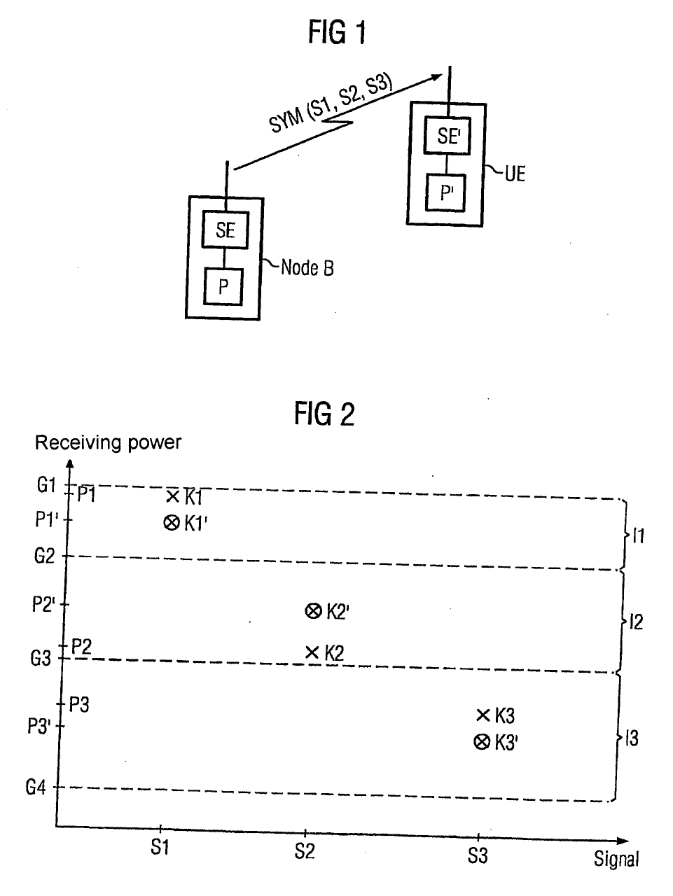

FIG. 1 is a schematic of a base station NodeB that transmits a symbol SYM to a user station UE over a radio link. Said transmitted symbol SYM is composed of three signals S1, S2, S3 that are transmitted in each case on a subcarrier, which is to say are in each case modulated onto a carrier frequency. The user station UE reconstitutes the symbol SYM transmitted by the base station NodeB from the demodulated signals S1, S2, S3.

The base station NodeB has a transmitting and receiving unit SE that is controlled by a processor P. The user station UE likewise has a transmitting and receiving unit SE′ as well as a processor P′ for controlling its transmitting and receiving unit SE′. Channel state information (CSI) for each of the three subcarriers is known to the base station NodeB. Said channel state information is either measured by the user station UE and signaled to the base station NodeB or determined by the base station NodeB itself. The base station NodeB sets a value for the transmitting power of the signals S1, S2, S3 for each of the three subcarriers by its processor P.

An exemplary embodiment of setting of the transmitting power for the signals S1, S2, S3 transmitted by the base station NodeB is explained below with the aid of FIG. 2.

In the schematic diagram in FIG. 2 the abscissa shows the three signals S1, S2, and S3, while the receiving power estimated on the transmitter side for the three signals S1, S2, S3 for in each case two values of the transmitting power as well as the values of three predefined receiving-power intervals I1, I2, I3 can be read on the ordinate. The position of the signals S1, S2, S3 on the abscissa is defined by, for example, the carrier frequency of the corresponding subcarrier.

The predefined receiving-power intervals I1, I2, I3 are known to both the base station NodeB and the user station UE. The first predefined receiving-power interval I1 has as its upper limit a receiving-power value GI and as its lower limit a receiving-power value G2. The lower limit of the first receiving-power interval I1 is at the same time the upper limit of the second receiving-power interval I2. The lower limit of the second receiving-power interval I2 has the value G3, which is at the same time the upper limit of the third receiving-power interval I3. The lower limit of the third receiving-power interval I3 is G4. What applies is G1>G2 >G3 >G4.

On the basis of the channel state information known to it for the first subcarrier on which the first signal S1 is transmitted, for a first value of the transmitting power, which value is predetermined for the first subcarrier, the base station NodeB estimates a first value P1 of the receiving power of the first signal S1, which value is indicated by a first cross K1. The first estimated value P1 of the receiving power lies in the first receiving-power interval I1 and lies close to the upper limit G1 of the first receiving-power interval I1. The base station NodeB selects a second value of the transmitting power, which value will actually be used for transmitting the first signal S1, in such a way that a second value P1′ of the receiving power of the first signal, indicated by a first cross in the circle K1′, which value is estimated using the second value of the transmitting power, lies in the center of the first receiving-power interval I1. The estimated second value P1′ of the receiving power of the first signal S1 thus lies at (G2−G1)/2.

For the second and third signal S2, S3 the base station NodeB likewise estimates in each case a first value P2, P3 of the receiving power for in each case a predetermined first value of the transmitting power of the signals S2, S3. For the second signal S2, P2 is produced as the first estimated value of the receiving power and for the third signal S3, P3 is produced as the first estimated value of the receiving power. The first estimated values P2, P3 of the receiving power of the second and third signal S2, S3 are indicated in the diagram by a second and third cross K2, K3.

In the exemplary embodiment relating to FIG. 2, the respective predetermined first value of the transmitting power has the same numerical value for all subcarriers. However, an individual predetermined first value of the transmitting power can, of course, also be used for each subcarrier.

The base station NodeB uses in each case a second value of the transmitting power for transmitting the second and third signals S2, S3 so that second values P2′, P3′, estimated for the respective second value of the transmitting power, of the receiving power of the second and third signal S2, S3 will in each case lie in the center of the receiving-power intervals in which the values P2, P3, estimated previously for the respective predetermined first values of the transmitting power, of the receiving power lay. The second values P2′ P3′, estimated for the respective second value of the transmitting power, of the receiving power are indicated by a second and third cross in the circle K2′, K3′. The second estimated value P2′ of the receiving power of the second signal S2 lies in the center of the second receiving-power interval I2 and the second estimated value P3′ of the receiving power of the third signal S3 lies in the third receiving-power interval I3.

An assignment, in the form of, for example, a table, of the three receiving-power intervals I1, I2, I3 to in each case one modulation type is known in the base station NodeB and user station UE. For transmitting, for the three signals S1, S2, and S3 the base station NodeB selects in each case the specific modulation type assigned to the receiving-power interval in which the in each case first estimated values P1, P2, P3 of the receiving power lie. The base station NodeB uses the respective second value of the transmitting power as the transmitting power of the three signals S1, S2, S3. The values actually measured by the user station UE of the receiving power of the signals S1, S2, S3 will consequently also lie more probably within the corresponding receiving-power intervals I1, I2, I3 than would be the case were the in each case predetermined first value of the transmitting power used. Using the measured values of the receiving power of the signals S1, S2, S3, the user station UE determines the modulation method assigned to the respective receiving-power interval and demodulates the signals S1, S2, S3 by reversing the relevant modulation method.

The signals S1, S2, S3 transmitted on the subcarriers can be, for example, pilot signals which the user station UE uses—as well as for determining modulation methods for signals of the subcarriers—for estimating the relevant subcarrier's transmission channel. Repeated determining of the respective modulation method on the receiver side can in this case be dispensed with for signals subsequently transmitted on the subcarriers and serving, for example, to transmit useful data such as image and/or voice data, provided it can be assumed on the receiver side that the transmission conditions have not substantially changed since the pilot signal were received. The base station NodeB therefore transmits the pilot signals at a repetition rate that will be the greater the faster the transmission characteristics for signals of the subcarriers change.

Values of the receiving power lower than those lying in the first and second receiving-power interval I2, I3 lie in the third receiving-power interval I3. If the signal-to-noise ratio is poor, the user station UE may thus possibly measure a value of the receiving power deviating substantially from the value of the receiving power previously estimated by the base station NodeB. In order, in a case such as this, to prevent the actually measured value of the receiving power from lying outside the third receiving-power interval I3, and hence a modulation method different from that previously selected by the base station NodeB from being determined by the user station UE, the third receiving-power interval I3 is larger than the second receiving-power interval I2 because the second receiving-power interval I2 has higher values of the receiving power than does the third receiving-power interval I3. The second receiving-power interval I2 is in turn larger than the first receiving-power interval II because the first receiving-power interval II has higher values of the receiving power than does the second receiving-power interval I2. The size of the receiving-power intervals I1, I2, I3 can, for example, be selected such that, considered statistically, the probability of selecting an incorrect modulation method for the user station UE based on the receiving-power interval determined by it has approximately the same value for all receiving-power intervals.

What is achieved as a result of the transmitting power actually used for transmitting individual subcarriers' signals having not been predefined, being instead matched to the transmission channel's transmission characteristics at the respective subcarrier's frequency in such a way that the estimated values of the receiving power will in each case lie in the center of a receiving-power interval, is that the user station UE will determine the correct modulation type with greater probability than would be the case were all the subcarriers' signals transmitted from the base station NodeB at the same transmitting power according to known methods.

The method can, of course, also be advantageously applied if only signals of one subcarrier are present or if a substantially larger number of subcarriers are used than illustrated in FIG. 2.

The method can, of course, also be used for transmissions from the user station UE to the base station NodeB.

The difference between the second and first values, estimated for the three signals S1, S2, S3, of the receiving power, which is to say P1′−P1, P2′−P2, and P3′−P3, is for example proportional to the corresponding difference between the respective second and first values of the transmitting power of the base station NodeB. If, as in FIG. 2, the same first predetermined value of the transmitting power is used for all three signals S1, S2, S3, then it can be seen directly from FIG. 2 that the second values of the transmitting power of the first and third signal S1, S3 are lower than the first predetermined value of the transmitting power, while for the second signal S2 the second value of the transmitting power is higher than the first predetermined value of the transmitting power. If, though, averaging is performed across all three signals S1, S2, S3, then during transmission using the respective second values of the transmitting power the overall transmitting power required will be approximately the same as that required had all signals S1, S2, S3 been transmitted in each case using the first predetermined value of the transmitting power. In the exemplary embodiment relating to FIG. 2 the sum of the second values of the transmitting power is therefore approximately three times the first predetermined value of the transmitting power. On average, therefore, no additional transmitting power will be needed for the method. Viewed statistically, that will apply all the more the greater is the number of signals transmitted over different subcarriers.

In an embodiment the second transmitting-power value used for the signals S1, S2, S3 is continuously matched by the base station NodeB, taking account of prevailing channel characteristics determined on the transmitter side, in such a way that further signals transmitted on the subcarriers at the matched transmitting power will likewise be received by the user station UE using the second value, estimated for the signals S1, S2, S3, of the receiving power. In that way, channel estimating on the receiver side, which is to say channel estimating performed by the user station UE, will not be necessary unless for signals of at least one subcarrier the base station NodeB selects a value of the transmitting power for which value there is a changed estimated value of the receiving power in another receiving-power interval. The base station will select, for example, a value of the transmitting power for which value there is a changed estimated value of the receiving power in another receiving-power interval if the channel characteristics have changed so much that it will be, for example, more favorable in terms of energy to select a new value of the transmitting power and a new modulation type in keeping with the changed receiving-power interval.

As described in the last paragraph, the base station can of course, through continuous matching of its transmitting power, also keep an estimated value of the receiving power constant when said value does not lie in the center of the receiving-power interval.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-8. (canceled)

9. A method for wireless communication using an actual transmit power at a transmitter, comprising:
dividing a symbol into a plurality of signals and separately transmitting each of the signals;
receiving the signals at a receiver, each signal being received in one of a plurality of receive power intervals; and
separately selecting a demodulation method for each signal based upon the receive power interval at which the signal was received, wherein
before transmission, an estimated receive power interval is determined for each signal based on a hypothetical transmit power, and a first estimated receive power is determined within that estimated receive power interval,
the hypothetical transmit power is corrected for each signal to produce the actual transmit power that will produce a second estimated receive power, which is closer to a middle of the estimated receive power interval than the first estimated receive power, and
each of the signals is separately modulated at the transmitter using a modulation method corresponding to the estimated receive power interval.

10. A method for determining a transmitting power required for a signal to be transmitted from a transmitting station to a receiving station, comprising:
for a first value of the transmitting power, estimating a first value of a receiving power at the receiving station within a predefined receiving-power interval, the first value of the receiving power being estimated at a transmitter side;
determining a second value of the transmitting power at the transmitter side, which second value of the transmitting power would produce an estimated second value of the receiving power that lies closer to a center of the predefined receiving-power interval than does the first value of the receiving power; and
using the second value of the transmitting power for transmitting the signal.

11. The method as claimed in claim 10, wherein
there are at least two predefined receiving-power intervals in which the first value of the transmitting power could lie, and
the signal is modulated at the transmitter side using a modulation type selected based on which of at least two predefined receiving-power intervals includes the first value of the transmitting power.

12. The method as claimed in claim 10 wherein
the second value of the transmitting power is determined such that the estimated second value of the receiving power lies substantially in the center of the predefined receiving-power interval.

13. The method as claimed in claim 10, wherein
a symbol is divided into a plurality of signals that are separately transmitted using different carrier frequencies, and
each signal is separately treated in an analogous manner to estimate a first value of a receiving power based on a first value of the transmitting power, to determine a second value of the transmitting power, and to use the second value of the transmitting power for transmitting the signal.

14. The method as claimed in claim 10, wherein the signal is a pilot signal.

15. The method as claimed in claim 11, wherein
a first predefined receiving-power interval is larger than a second predefined receiving-power interval, and
receiving powers within the first predefined receiving-power interval are lower than receiving powers within the second predefined receiving-power interval.

16. The method as claimed in claim 10, wherein
a predetermined value is used as the first value of the transmitting power.

17. The method as claimed in claim 11, wherein
the second value of the transmitting power is determined such that the estimated second value of the receiving power lies substantially in the center of the predefined receiving-power interval.

18. The method as claimed in claim 17, wherein
a symbol is divided into a plurality of signals that are separately transmitted using different carrier frequencies, and
each signal is separately treated in an analogous manner to estimate a first value of a receiving power based on a first value of the transmitting power, to determine a second value of the transmitting power, and to use the second value of the transmitting power for transmitting the signal.

19. The method as claimed in claim 18, wherein the plurality of signals are pilot signals.

20. The method as claimed in claim 19, wherein
a first predefined receiving-power interval is larger than a second predefined receiving-power interval, and
receiving powers within the first predefined receiving-power interval are lower than receiving powers within the second predefined receiving-power interval.

21. The method as claimed in claim 20, wherein
a predetermined value is used as the first value of the transmitting power.

22. A device for determining a transmitting power required for a signal to be transmitted from a transmitting station to a receiving station, comprising:
an estimation unit to estimate a first value of a receiving power at the receiving station, within a predefined receiving-power interval, the first value being estimated based on an assumption that a hypothetical first transmitting power is used at the transmitting station, the first value of the receiving power being estimated at a transmitter side; and
a determination unit to determine a second value of the transmitting power at the transmitter side, which second value of the transmitting power would produce an estimated second value of the receiving power that lies closer to a center of the predefined receiving-power interval than does the first value of the receiving power, the second value of the transmitting power being used to transmit the signal.
